(19) United States
(12) Patent Application Publication
(10) Pub. No.: US 2019/0258522 A1
(43) Pub. Date: Aug. 22, 2019

(54) INFORMATION PROCESSING APPARATUS AND INFORMATION PROCESSING METHOD

(71) Applicant: KYOCERA Document Solutions Inc., Osaka (JP)

(72) Inventors: Masato Tanba, Osaka (JP); Kyoichiro Hayashi, Osaka (JP); Shinichi Hashimoto, Osaka (JP); Satoshi Hayama, Osaka (JP)

(21) Appl. No.: 16/273,772

(22) Filed: Feb. 12, 2019

(30) Foreign Application Priority Data
Feb. 20, 2018 (JP) 2018-028047

(51) Int. Cl. G06F 9/50; G06F 9/54; G06F 3/06; G06F 11/07

(52) U.S. Cl. CPC G06F 9/5016; G06F 9/542; G06F 11/076; G06F 3/0646; G06F 3/0688; G06F 3/0616

(57) ABSTRACT

An information processing apparatus includes a nonvolatile memory, a count processing portion, and an execution processing portion. The count processing portion is configured to count, for each cycle of a specific time period, a write count that is a number of times data has been written to the nonvolatile memory. The execution processing portion is configured to execute a specific process when the write count that is counted during the specific time period by the count processing portion reaches a specific count.

### INCORPORATION BY REFERENCE

This application is based upon and claims the benefit of priority from the corresponding Japanese Patent Application No. 2018-028047 filed on Feb. 20, 2018, the entire contents of which are incorporated herein by reference.

### BACKGROUND

The present disclosure relates to an information processing apparatus and an information processing method.

There is known a method of estimating a lifetime of a flash memory, based on information indicating a sign of deterioration of the flash memory (for example, an occurrence rate of data readout errors, and information such as the number of pulses that is necessary for writing data).

### SUMMARY

An information processing apparatus according to an aspect of the present disclosure includes a nonvolatile memory, a count processing portion, and an execution processing portion. The count processing portion is configured to count, for each cycle of a specific time period, a write count that is a number of times data has been written to the nonvolatile memory. The execution processing portion is configured to execute a specific process when the write count that is counted during the specific time period by the count processing portion reaches a specific count.

An information processing method according to another aspect of the present disclosure includes a counting step and an execution step. In the counting step, a write count that is a number of times data has been written to a nonvolatile memory, is counted for each cycle of a specific time period. In the execution step, a specific process is executed when the write count that is counted during the specific time period in the counting step reaches a specific count.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a system configuration of an image forming apparatus according to an embodiment of the present disclosure.

FIG. 2 is a diagram showing an example of write count information that is used in the image forming apparatus according to the embodiment of the present disclosure.

FIG. 3 is a flowchart showing an example procedure of an information process that is executed in the image forming apparatus according to the embodiment of the present disclosure.

FIG. 4 is a diagram showing an example of an alert screen that is used in the image forming apparatus according to the embodiment of the present disclosure.

FIG. 5 is a diagram showing an example of an alert screen that is used in the image forming apparatus according to the embodiment of the present disclosure.

### DETAILED DESCRIPTION

The following describes an embodiment of the present disclosure with reference to the accompanying drawings. It should be noted that the following embodiment is an example of a specific embodiment of the present disclosure and should not limit the technical scope of the present disclosure.

[Configuration of Image Forming Apparatus]

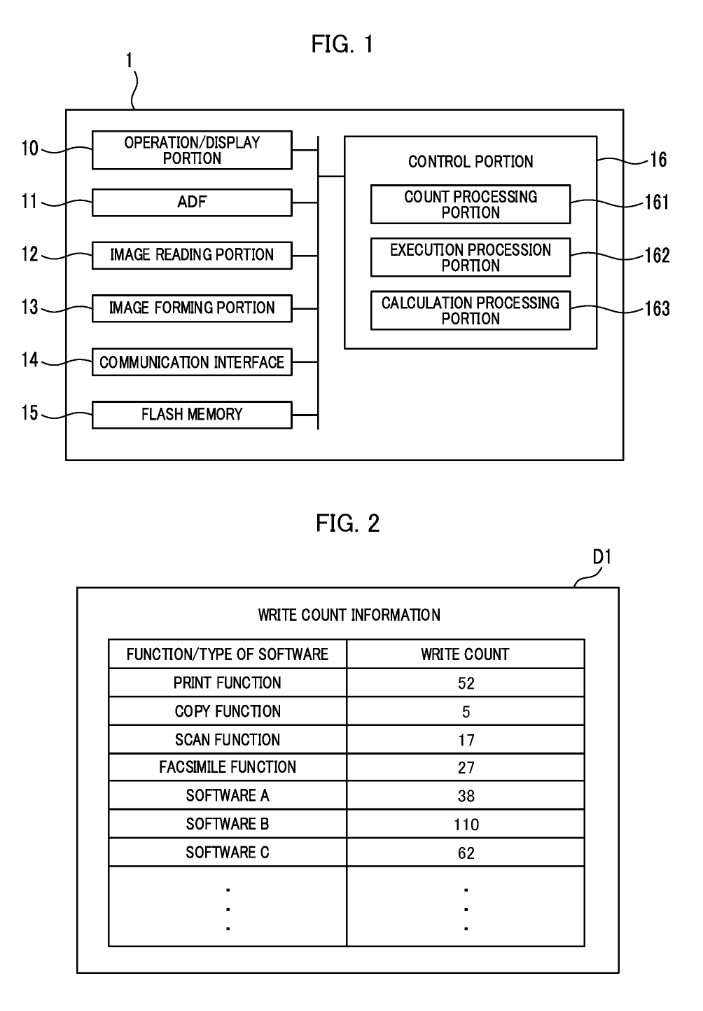

As shown in FIG. 1, an image forming apparatus 1 according to an embodiment of the present disclosure includes an operation/display portion 10, an ADF (Auto Document Feeder) 11, an image reading portion 12, an image forming portion 13, a communication interface 14, a flash memory 15, and a control portion 16. Specifically, the image forming apparatus 1 is a multifunction peripheral having a printer function, a scanner function, a copy function, a facsimile function, or the like. It is noted that the present disclosure is not limited to a multifunction peripheral, and is applicable to image forming apparatuses such as a copier, a printer, and a facsimile apparatus. Furthermore, the present disclosure is applicable to any information processing apparatus including a nonvolatile memory. The image forming apparatus 1 is an example of an “information processing apparatus” according to the present disclosure.

The operation/display portion 10 includes a display portion such as a liquid crystal display for displaying information, and an operation portion such as a touch panel and operation buttons for receiving a user operation.

The ADF 11 includes a document setting portion, a conveying roller, a document holder, and a sheet discharge portion, and is an automatic document feeding device for feeding a document to be read by the image reading portion 12.

The image reading portion 12 includes a document table, a light source, a mirror, an optical lens, and a CCD (Charge Coupled Device), and is configured to read an image from a document and output the image as image data.

The image forming portion 13 is configured to execute a print process based on the image data by an electrophotographic method or an inkjet method, and form an image on the document based on the image data. For example, in a case where the image forming portion 13 is an electrophotographic image forming portion, the image forming portion 13 includes a photoconductor drum, a charger, an exposure device, a developing device, a transfer device, and a fixing device.

The communication interface 14 is configured to execute a communication process according to a predetermined communication protocol with an information processing device such as an external facsimile device or a personal computer, via a communication network such as a telephone line, the internet, or a LAN.

The flash memory 15 is a nonvolatile storage portion. The flash memory 15 stores various control programs executed by the control portion 16, and various types of data (for example, image data, log data, user information, setting information). The flash memory 15 is an example of a “nonvolatile memory” according to the present disclosure. The flash memory 15 is characteristic in that its lifetime changes in response to a write count, that is, the number of times data has been written thereto.

Meanwhile, in an image forming apparatus such as a multifunction peripheral, a nonvolatile memory such as the flash memory 15, whose lifetime changes in response to the write count, may be installed as storage for storing data such as image data. In this case, a type or capacity of the nonvolatile memory is decided so that an assumed lifetime (service life) of the nonvolatile memory is longer than an assumed lifetime of the image forming apparatus. However, if data is written to the nonvolatile memory at a write frequency that is higher than what was assumed when the image forming apparatus was manufactured, an actual lifetime of the nonvolatile memory may become shorter than its assumed lifetime. To solve this issue, the image forming apparatus 1 according to the present embodiment may be used to prevent the actual lifetime of the nonvolatile memory from becoming shorter than the assumed lifetime.

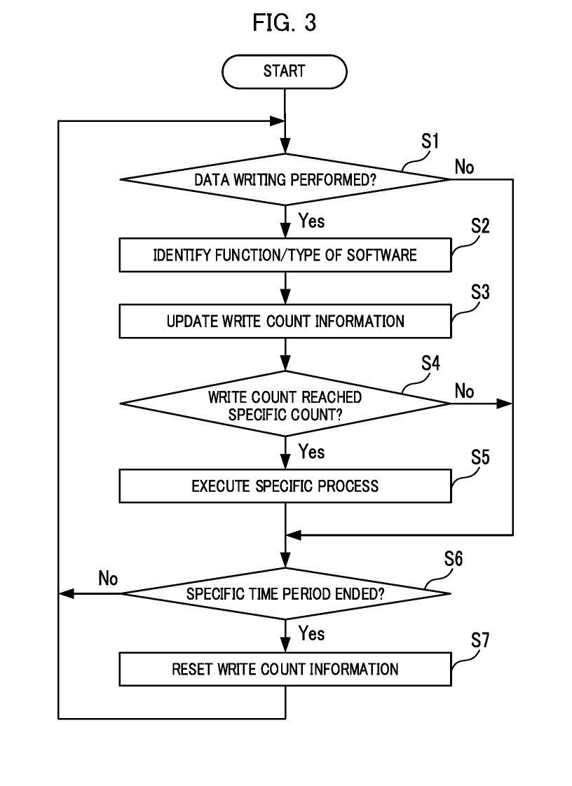

Write count information D1 (see FIG. 2) is stored in the flash memory 15. The write count information D1 is created and updated by the control portion 16 in an information process (see FIG. 3) described later. The write count information D1 includes information indicating, for each function and each type of software that uses the flash memory 15, the write count of data writing to the flash memory 15.

The control portion 16 includes control devices such as a CPU, a ROM, and a RAM. The CPU is a processor for executing various kinds of arithmetic processing. The ROM is a nonvolatile storage portion in which information such as a control program for making the CPU execute various processes is preliminarily stored. The RAM is a volatile or nonvolatile storage portion used as a temporary storage memory (work area) for various processes executed by the CPU.

Specifically, the control portion 16 includes a count processing portion 161, an execution processing portion 162, and a calculation processing portion 163. It is noted that the control portion 16 functions as these processing portions by executing various processes according to the control program. In addition, the control portion 16 may be provided with one or more electronic circuits for realizing a part of these processing portions or a plurality of processing functions.

The count processing portion 161 counts the write count of data writing to the flash memory 15 for each cycle of a specific time period (for example, 24 hours). Information on the write counts that are counted by the count processing portion 161 may be stored in the flash memory 15 as the write count information D1. It is noted that in another embodiment, the write count information D1 may be stored in another storage portion (for example, the RAM) instead of the flash memory 15.

Meanwhile, when new data (a file) is written to the flash memory 15, address information that indicates a storage position of the data in the flash memory 15 (for example, information indicating a block in which the data is stored) is created and stored in the flash memory 15. When data stored in the flash memory 15 is changed, data after the change is written at a storage position different from where the data was stored before the change, and the address information corresponding to the data is updated. Then, when the address information corresponding to the stored data is changed, the count processing portion 161 updates the write count.

It is noted that the count processing portion 161 may count the write count for each function and each type of software that uses the flash memory 15. For example, when address information of a piece of data stored in the flash memory 15 has been changed, the count processing portion 161 may identify a function or a type of software that uses the piece of data based on an extension included in a file name of the piece of data.

The execution processing portion 162 executes a specific process when the write count counted during the specific time period by the count processing portion 161 reaches a specific count. It is noted that in the case where the count processing portion 161 counts the write count for each function and each type of software, the execution processing portion 162 may execute the specific process when a total write count of all write counts for the functions and the types of software reaches the specific count.

It is noted that the specific count may be preset based on the write count of data writing to the flash memory 15 during the specific time period, when the image forming apparatus 1 is used in a normal way. Alternatively, the specific count may be set or changed to an arbitrary number in response to a user operation. Alternatively, the specific count may be calculated constantly by the calculation processing portion 163.

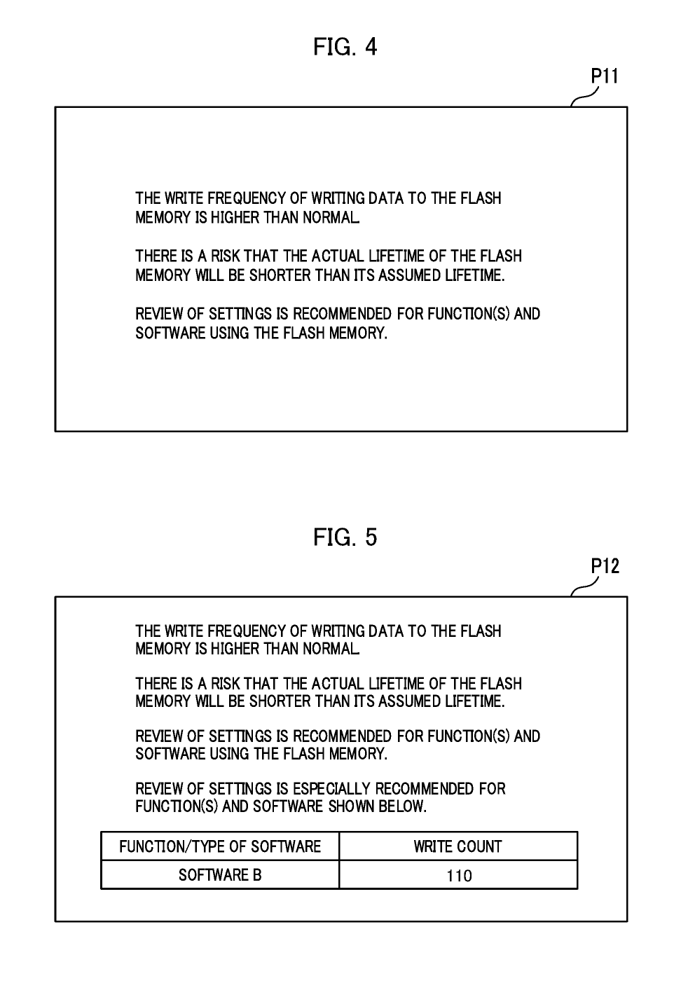

It is noted that the specific process may include a process of showing a predetermined alert message to the user (see FIG. 4). This prompts the user to perform an operation (for example, changing setting information of a function or a type of software that uses the flash memory 15) that is necessary for reducing the write frequency of writing data to the flash memory 15. For example, for a print function, the user may arbitrarily choose whether or not to store in the flash memory 15 image data used for a print job. In this case, by changing setting information of the print function so that the image data is not stored in the flash memory 15, the write frequency can be reduced. In addition, during execution of management software, information indicating a status of the image forming apparatus 1 may be recorded in the flash memory 15 as log information at a predetermined recording cycle. In this case, by changing setting information of the software so that the recording cycle becomes longer, the write frequency of writing data to the flash memory 15 can be reduced.

It is noted that the specific process may include at least a process of indicating, to the user, information on a function or a type of software that has the highest write count (see FIG. 5). This allows for the user to easily recognize the function or the type of software that has the highest write count of data writing to the flash memory 15, and efficiently perform an operation that is necessary for reducing the write frequency of data writing to the flash memory 15.

In addition, the specific process may include at least a process of changing setting information of a function or a type of software that has the highest write count. The setting information may indicate a length of an update cycle of a specific piece of data (a file) that is stored in the flash memory 15. In this case, the execution processing portion 162 may automatically change the setting information so that the changed update cycle becomes longer than the present update cycle. With this configuration, the write frequency of writing data to the flash memory 15 can be reduced. It is noted that the setting information to be changed is not limited to the length of the update cycle, and may be an arbitrary piece of setting information. For example, the setting information may indicate whether or not to write to the flash memory 15 image data of a document during execution of a copy job. In this case, the execution processing portion 162 may automatically change the setting information so that the image data of the document is not written to the flash memory 15. With this configuration, the write frequency of writing data to the flash memory 15 can be reduced.

In addition, the specific process may include a process of changing the device to store the data from the flash memory 15 to another nonvolatile memory (for example, a hard disk drive). With this configuration, the write frequency of data written to the flash memory 15 can be reduced.

The calculation processing portion 163 calculates the specific count based on a result obtained by dividing a remaining writable count of the flash memory 15 by a remaining lifetime of the image forming apparatus 1, wherein the remaining writable count is the remaining number of times data can be written to the flash memory 15, and the remaining lifetime is the remaining number of days in the lifetime of the image forming apparatus 1. It is noted that the remaining writable count may be calculated by subtracting, from a preset writable count, a cumulative write count that has been counted from when the image forming apparatus 1 was first used until the present time. In addition, the remaining lifetime may be calculated by subtracting, from a preset remaining lifetime, the number of days that have passed from when the image forming apparatus 1 was first used until the present time. In this way, by dynamically calculating the specific count based on the result obtained by dividing the remaining writable count by the remaining lifetime, the specific process can be executed at a more appropriate timing.

[Information Process]

Next, with reference to FIG. 3, an example of a procedure of an information process executed by the control portion 16 is described. Here, steps S1, S2, . . . represent numbers of processing procedures (steps) executed by the control portion 16. It is noted that the information process may be started in response to powering on the image forming apparatus 1, and may end in response to powering off the image forming apparatus 1.

<Step S1>

First, in step S1, the control portion 16 determines whether or not data has been written to the flash memory 15. Specifically, when the address information corresponding to data stored in the flash memory 15 has been changed, the control portion 16 determines that data has been written to the flash memory 15. When the control portion 16 determines that data has been written to the flash memory 15 (S1: Yes), the process moves to step S2. On the other hand, when the control portion 16 determines that data has not been written to the flash memory 15 (S1: No), the process moves to step S6.

<Step S2>

In step S2, the control portion 16 identifies a function or a type of software that has written the data to the flash memory 15. Specifically, based on an extension included in a file name of the data written to the flash memory 15, the control portion 16 identifies the function or the type of software that has written the data to the flash memory 15.

<Step S3>

In step S3, the control portion 16 updates the write count information D1. Specifically, the control portion 16 increments, in the write count information D1, a write count corresponding to the function or the type of software that was identified in step S2. Step S3 is an example of a “count step” according to the present disclosure. Processing in step S3 is executed by the count processing portion 161 of the control portion 16.

<Step S4>

In step S4, the control portion 16 determines whether or not the write count of data writing to the flash memory 15 (specifically, a total write count of all write counts for the functions and the types of software) has reached the specific count. Then, when the control portion 16 determines that the write count of data writing to the flash memory 15 has reached the specific count (S4: Yes), the process moves to step S5. On the other hand, when the control portion 16 determines that the write count of data writing to the flash memory 15 has not reached the specific count (S4: No), the process moves to step S6.

<Step S5>

In step S5, the control portion 16 executes the specific process. Specifically, as an example of the specific process, the control portion 16 may display on the operation/display portion 10 an alert screen P11 shown in FIG. 4. The alert screen P11 displays a message prompting the user to review settings for a function or a type of software that uses the flash memory 15. It is noted that in another embodiment, as an example of the specific process, the control portion 16 may display on the operation/display portion 10 an alert screen P12 as shown in FIG. 5. The alert screen P12 displays, in addition to the message prompting the user to review settings for a function or a type of software that uses the flash memory 15, information indicating a function or a type of software (in this example, software B) that has a highest write count of data writing to the flash memory 15. It is noted that in another embodiment, the alert screen P12 may display information indicating a plurality of functions or types of software selected in descending order of write count of data writing to the flash memory 15 during the specific time period. The step S5 is an example of an “executing step” according to the present embodiment. Processing in step S5 is executed by the execution processing portion 162 of the control portion 16.

<Step S6>

In step S6, the control portion 16 determines whether or not the specific time period has ended. Specifically, the control portion 16 determines that the specific time period has ended when a fixed time period (for example, 24 hours) has passed from when the information process was started, or when the fixed time period has passed from when the write count information D1 was reset as described in step S7 below. When the control portion 16 determines that the specific time period has ended (S6: Yes), the process moves to step S7. On the other hand, when the control portion 16 determines that the specific time period has not ended (S6: No), the process returns to step S1.

<Step S7>

In step S7, the control portion 16 resets the write count information D1. Specifically, the control portion 16 resets, to 0, values of the write counts that correspond to the functions and types of software included in the write count information D1. Then, the process returns to step S1.

As described above, in the image forming apparatus 1 according to the present embodiment, the write count of data writing to the flash memory 15 is counted for each cycle of the specific time period. When the write count during the specific time period reaches the specific write count, the control portion 16 executes the specific process (for example, displays the alert screen P11 shown in FIG. 4). As a result, the write frequency of writing data to the flash memory 15 can be reduced. By using the image forming apparatus 1 according to the present embodiment, it is possible to prevent the actual lifetime of the flash memory 15 from becoming shorter than its assumed lifetime.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An information processing apparatus, comprising:
a nonvolatile memory;
a count processing portion configured to count, for each cycle of a specific time period, a write count that is a number of times data has been written to the nonvolatile memory; and
an execution processing portion configured to execute a specific process when the write count that is counted during the specific time period by the count processing portion reaches a specific count.

2. The information processing apparatus according to claim 1, wherein
the specific process includes a process of showing a predetermined alert message to a user.

3. The information processing apparatus according to claim 1, wherein
the count processing portion counts the write count for each function or each type of software that uses the nonvolatile memory, and
the specific process includes a process of showing, to a user, information indicating at least a function or a type of software that has a highest write count.

4. The information processing apparatus according to claim 1, wherein
the count processing portion counts the write count for each function or each type of software that uses the nonvolatile memory, and
the specific process includes a process of changing setting information of at least a function or a type of software that has a highest write count.

5. The information processing apparatus according to claim 1, wherein
the specific process includes a process of changing a place to store the data from the nonvolatile memory to another nonvolatile memory.

6. The information processing apparatus according to claim 1, wherein
when address information that indicates a storage position of data stored in the nonvolatile memory is changed, the count processing process updates the write count.

7. The information processing apparatus according to claim 1, further comprising
a calculation processing portion configured to calculate the specific count based on a result obtained by dividing a remaining number of times data can be written to the nonvolatile memory, by a remaining number of days in a lifetime of the information processing apparatus.

8. An information processing method, comprising:
counting, for each cycle of a specific time period, a write count that is a number of times data has been written to a nonvolatile memory; and
executing a specific process when the write count that is counted during the specific time period reaches a specific count.
